(19) United States
(12) Patent Application Publication
(10) Pub. No.: US 2019/0364243 A1
(43) Pub. Date: Nov. 28, 2019

(54) METHOD AND DEVICE FOR DUAL CODECS TO TRANSFER DIGITAL CONTENT

(71) Applicant: Lenovo (Singapore) Pte. Ltd., New Tech Park (SG)

(72) Inventors: Omar Ali Ali, Cary, NC (US); Alan Ladd Painter, Apex, NC (US); Marc Pamley, Durham, NC (US); Billy Chen, Raleigh, NC (US); Rodrigo Samper, Raleigh, NC (US)

(21) Appl. No.: 15/988,857

(22) Filed: May 24, 2018

(51) Int. Cl. H04N 7/01; G06F 3/16

(52) U.S. Cl. CPC H04N 7/01; G06F 3/162

(57) ABSTRACT

A method and device are provided. The electronic device includes a main circuit board that includes first and second edges and first and second sets of conductive traces. The device includes a memory to store program instructions. The processor, responsive to the program instructions, manages transfer of a digital content signal over the first and second sets of conductive traces. The device includes first and second codecs are coupled to the first and second edges, respectively. The first and second codecs are connected to the first and second sets of conductive traces, respectively. The first and second codecs convert the digital content signal into an analog content signal. The device includes first and second analog outputs coupled to the first and second codecs, respectively. The first and second analog outputs to output the analog content signal.

### BACKGROUND

Embodiments herein generally relate to methods and devices using dual codecs to transfer digital content signals.

Today, edges of a motherboard require the need to have an audio shielded cable from a back of the motherboard to a front of the motherboard. A codec is positioned in the back of the motherboard coupled to an audio jack. The audio shielded cable is sensitive to the digital noise emitted from the motherboard. The codec is coupled to noise isolation of the motherboard. The codec shares the same isolated analog power/ground planes with the Analog outputs located on the front or rear face. Additionally, the audio shielded cable between the edges of the motherboard need headers placed nearby the mother board. The headers of the audio shielded cable are coupled to the mother board. The headers may take space and/or connection to the motherboard. The audio shielded cable is expensive, long, hard to route, and are very susceptible to noise.

### SUMMARY

In accordance with embodiments herein, an electronic device is provided. The electronic device includes a main circuit board that includes first and second edges and first and second sets of conductive traces. The electronic device includes a memory to store program instructions. The electronic device includes a processor located on the main circuit board, the processor, responsive to the program instructions, manages transfer of a digital content signal over the first and second sets of conductive traces. The electronic device includes first and second codecs coupled to the first and second edges, respectively. The first and second codecs are connected to the first and second sets of conductive traces, respectively. The first and second codecs convert the digital content signal into an analog content signal. The electronic device includes first and second analog outputs coupled to the first and second codecs, respectively. The first and second analog outputs output the analog content signal.

Optionally, the first and second sets of conductive traces form non-cable digital interfaces to the first and second codecs. Additionally or alternatively, the first and second sets of conductive traces include edge contacts coupled to the first and second edges of the main circuit board. The first and second codecs include codec contacts that directly engage corresponding to the edge contacts. Optionally, the electronic device includes a peripheral controller hub located on the main circuit board. The first and second sets of conductive traces include hub contacts located in coupled to the peripheral controller hub. The peripheral controller hub includes contacts that directly engage corresponding hub contacts.

Optionally, the main circuit board includes a ground plane extending parallel to the first and second conductive traces. Additionally or alternatively, the electronic device includes a peripheral circuit board having the second codec and second analog output mounted thereon. The peripheral circuit board interconnects through a card-edge and socket interface, to the second set of conductive traces at the second edge of the main circuit board. Optionally, the peripheral circuit board represents a front panel input/output. The second analog output includes an audio speaker and audio jack mounted on the front panel input/output. Additionally or alternatively, the digital content signal includes at least one of a digital audio content or a digital video content. Optionally, the analog outputs include at least one of an audio jack, a video jack, an audio speaker, and an analog video display.

In accordance with embodiments herein, a method is provided. The method is performed under control of a processor configured with program instructions to transfer a digital content signal over the first and second sets of conductive traces. The method includes providing a main circuit board that includes the first and second sets of conductive traces. The method includes designating first and second codecs coupled to the first and second edges of the main circuit board, respectively. The first and second codecs are connected to the first and second sets of conductive traces, respectively, the first and second codecs converting the digital content signal into an analog content signal. The method includes outputting first and second analog outputs coupled to the first and second codecs, respectively, the first and second analog outputs the analog content signal.

Optionally, the first and second sets of conductive traces form non-cable digital interfaces to the first and second codecs. Additionally or alternatively, the first and second sets of conductive traces include edge contacts coupled to the first and second edges of the main circuit board. The first and second codecs include codec contacts that directly engage corresponding edge contacts. Optionally, the method includes designating a peripheral controller hub located on the main circuit board. The first and second sets of conductive traces include hub contacts coupled to the peripheral controller hub. The peripheral controller hub includes contacts that directly engage corresponding hub contacts.

Optionally, the main circuit board includes a ground plane extending parallel to the first and second conductive traces. Additionally or alternatively, the method includes electrically coupling a peripheral circuit board having the second codec and second analog output mounted thereon. The peripheral circuit boardinterconnects, through a card-edge and socket interface, to thehe second set of conductive traces at the second edge of the main circuit board.

Optionally, the method includes electrically coupling a peripheral circuit board having the second codec and second analog output mounted thereon. The peripheral circuit board interconnects, through a card-edge and socket interface, to thehe second set of conductive traces at the second edge of the main circuit board. Additionally or alternatively, the peripheral circuit board represents a front panel input/output. The second analog output includes an audio speaker and audio jack mounted on the front panel input/output. Optionally, the digital signal includes one or more of digital audio content and digital video content.

In accordance with embodiments herein, an electronics card is provided. The electronics card includes a main circuit board that includes first and second edges. The main circuit board includes first and second sets of conductive traces to transfer a digital content signal. The electronics card includes first and second codecs coupled to the first and second edges, respectively. The first and second codecs are connected to the first and second sets of conductive traces, respectively. The first and second codecs convert the digital content signal into an analog content signal. The first and second analog outputs are coupled to the first and second codecs, respectively. The first and second analog outputs to output the analog content signal.

Optionally, the first and second sets of conductive traces form non-cable digital interfaces to the first and second codecs. Additionally or alternatively, the first and second sets of conductive traces include edge contacts coupled to the first and second edges of the main circuit board. The first and second codecs include codec contacts that directly engage corresponding edge contacts.

### BRIEF DESCRIPTION OF THE DRAWINGS

FIG. 1 illustrates a main circuit board, in accordance with embodiments herein.

FIG. 2 illustrates a peripheral circuit board, in accordance with embodiments herein.

FIG. 3 illustrates a process to manage a transfer of a digital content signal over the first and second sets of conductive traces of a main circuit board, in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, and/or the like. In other instances, well-known structures, materials, or operations are not shown or described in detail to avoid obfuscation. The following description is intended only by way of example and simply illustrates certain example embodiments.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

The term “digital content signal” as used throughout, refers to the digital content signal that includes digital audio content and/or digital video content. The digital audio content and/or the digital video content is based on a programmed instruction from a processor of the main circuit board. The digital content signal traverses along the main circuit board through first and second sets of conductive traces.

The term “peripheral circuit board” as used throughout, refers to a circuit board that is mounted to the main circuit board. Mounting the peripheral circuit board to the main circuit board allows the peripheral circuit board to be communicatively coupled to the first and second conductive transducers on the main circuit board. The peripheral circuit board includes front panel input/output (I/O). The I/O may include one or more interfaces, such as a second codec, a universal serial bus (USB), a micro USB, a USB 3.0, and/or the like. The I/O further may include a second analog output such as an audio speaker and/or an audio jack.

The term “peripheral controller hub” (PCH) as used throughout, refers to a processor that controls input/output functions between a processor of the main circuit board. The PCH controls the interfaces with first and second conductive traces on the main circuit board. The PCH can select the codecs and/or the I/O from a peripheral circuit board to the processor on the main circuit board. The PCH instructs the processor, which codec and/or I/O to be processed by the processor of the main circuit board.

The term “card-edge” and/or “socket interface” as used throughout, refers to a matching socket and/or a socket interface that includes the first and second conductive traces. The matching socket and/or the socket interface may represent a connector to operably couple the peripheral circuit board with the main circuit board. The matching socket and/or the socket interface may include an array of pins that interconnect the peripheral circuit board with the main circuit board. For example, the peripheral circuit board may be interconnected using the card-edge and/or the socket interface with a peripheral component interconnect, a digital interface, and/or the like. The card-edge and/or the socket interface allows the peripheral circuit board to communicate with the processor, the first and second codecs, the PCH on the main circuit board.

The term “edge contacts” as used throughout, refers to a socket interface for interfacing the first and second codecs to the main circuit board. The socket interface may include an array of pins that interface with the first and second codecs, respectively. For example, the first and second codecs may be contained within a package that interfaces with the array of pins of the interface socket. The interface may represent codec contacts that directly engage corresponding edge contacts of the socket interface. For example, the codec contacts interface with the PCH, the processor, the peripheral circuit board of the main circuit board along the first and second conductive traces. The first and second codecs contact are coupled to the first and second edges of the main circuit board.

Embodiments described herein describe an electronic device and/or methods. The electronic device includes a main circuit board that includes first and second edges. For example, first and second codecs may be positioned at the first and second edges of the main circuit board. The main circuit board includes first and second sets of conductive traces. The first and second sets of conductive traces allow communication between a peripheral controller hub (PCH), a peripheral circuit board, the processor of the main circuit board, the first and second codecs, and/or the like. The main circuit board includes a memory to store program instructions. For example, the processor of the main circuit board may execute the program instructions stored on the memory. The processor is located on the main circuit board. The processor, responsive to the program instructions, manages a transfer of a digital content signal over the first and second sets of conductive traces.

The first and second codecs are coupled to the first and second edges, respectively. The first and second codecs are connected to the first and second sets of conductive traces, respectively. The first and second sets of conductive traces form non-cable digital interfaces to the first and second codecs. The first and second codecs convert the digital content signal into an analog content signal. For example, the analog content signal is carried and/or transmitted along the first and second sets of conductive traces.

The first and second codecs are operably coupled to first and second analog outputs coupled to the first and second codecs, respectively, at the corresponding first and second edges. The first and second analog outputs, output the analog content signal to the user. The first and second analog outputs may include an audio jack, a video Jack, an audio speaker, an analog video display, and/or the like.

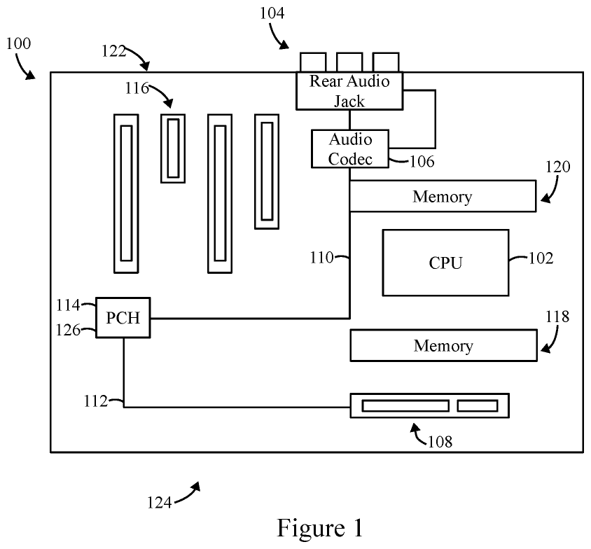

FIG. 1 illustrates a main circuit board 100. The main circuit board 100 includes a processor 102. The processor 102 may include one or more processors, a microprocessor, and/or the like. The processor 102 communicates with memories 118, 120, which store program instructions for the processor 102. The processor 102 is located on the main circuit board 100, and manages a transfer of a digital content signal over the first and second sets of conductive traces 110, 112.

The main circuit board 100 includes a ground plane and/or a power plane extending parallel to the first and second sets conductive traces 110, 112. The ground plane extends from the first codec 106 to the interconnect 108, the analog outputs, and/or the like. The ground plane may represent one of the layers of the main circuit board 100. For example, the ground plane may represent an analog ground for the main circuit board 100. The power plane provides electrical power to the processor 102, the peripheral controller hub (PCH) 114, the peripheral circuit board, the first and second audio codecs, and/or the like. For example, the power plane may represent one of the layers of the main circuit board 100.

The first and second sets of conductive traces 110, 112 form non-cable digital interfaces to the first codec 106. For example, the first and second sets of conductive traces 110, 112 include edge contact coupled to the first and second edges 122, 124 of the main circuit board 100. The edge contacts are coupled to the first and second edges 122, 124. The edge contact may represent interface sockets that receive the first codec 106. For example, the edge contact may include an array of pins that directly engage the corresponding edge contact to the first codec 106.

The main circuit board 100 includes a first codec 106. The first codec 106 is positioned coupled to a first edge 122 of the main circuit board 100. The first codec 106 is electrically coupled to an analog output 104. The analog output 104 may include an audio jack 204.

The first codec 106 may include one or more memories, a processor, and/or the like. The first codec 106 converts the digital content signal received from the processor 102 into an analog content signal. The analog content signal is carried by the first conductive trace 110. The first codec 106 is electrically coupled to the first conductive trace 110. Additionally or alternatively, the analog content signal may be received by the analog output 104.

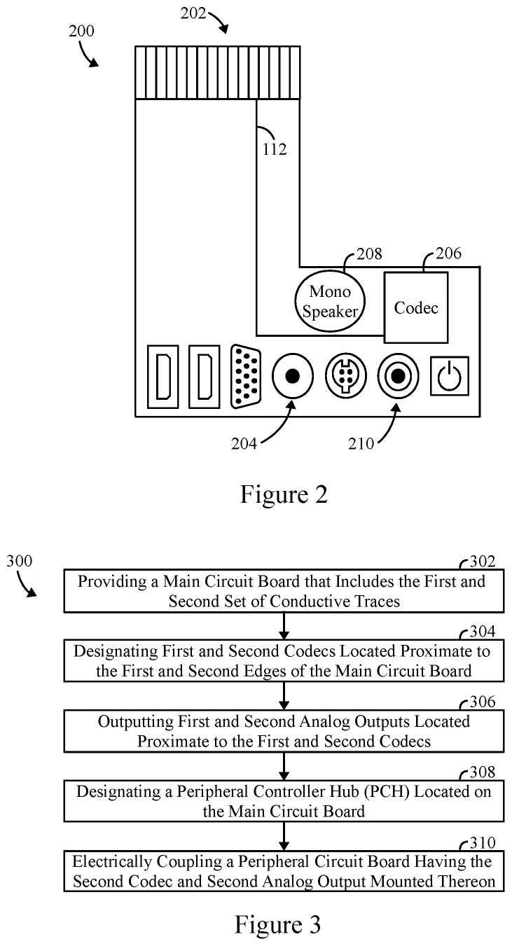

The first conductive trace 110 is electrically coupled to the peripheral controller hub (PCH) 114 located on the main circuit board 100. For example, the first and second sets of conductive traces 110, 112 are electrically coupled to the PCH 114. The first and second sets of conductive traces 110, 112 may be terminated at hub contacts 126. For example, the hub contacts 126 may represent a card-edge and/or a socket interface. The PCH 114 may be enclosed in a package that receives an array of pins that directly engage corresponding the hub contacts 126 of the PCH 114. The hub contacts 126 allow the PCH 114 to electrically interface through the first and second conductive traces 110, 112 to the first codec 106, the processor 102, a peripheral circuit board (shown in FIG. 2), a second codec, and/or the like.

Optionally, the PCH 114 may identify a connection to the audio jacks 210 (shown in FIG. 2). For example, the PCH 114 may identify a ground connection with an external audio source to the audio jack 204, 210. Based on the connection to the external audio source, the PCH 114 may determine a direction to transmit the audio content signal. For example, responsive to the connection at the audio jack 210, the PCH 114 may direct the audio content signal from the first codec 106 along the second set of conductive traces 112. In another example, responsive to the connection at the audio jack 204, the PCH 114 may direct the audio content signal from the second codec 206 along the first set of conductive traces 110.

Optionally, the PCH 114 may identify the use of the audio speaker 208 (shown in FIG. 2). For example, the PCH 114 may identify the use of the audio speaker 208 based on one or more inputs received from the processor 102. The PCH 114 may direct the audio content signal along the second set of conductive traces 112 to the second codec 206.

The main controller circuit 100 includes an interconnect 108. The interconnect 108 operably couples the main controller circuit 100 to a peripheral circuit board 200 (shown in FIG. 2).

FIG. 2 illustrates a peripheral circuit board 200. The peripheral circuit board 200 includes a second codec 206 and a second analog output (e.g., the audio speaker 208). For example, the second analog output may represent an audio speaker 208 and/or an audio jack 210. The peripheral circuit board 200 is interconnected with the main circuit board 100 through a card-edge and/or socket interface 202 through an interconnect 108. The second conductive trace 112 extends from the card-edge and/or the socket interface 202 to the second codec 206. For example, the second conductive trace 112 extends through the card-edge and/or the socket interface 202 to the peripheral circuit board 200 from the main circuit board 100.

The peripheral circuit board 200 includes the second codec 206. The second codec 206 is coupled to a second edge 124 of the main circuit board 100. The second codec 206 is electrically coupled to the second analog output. The second codec 206 may include one or more memories, a processor, and/or the like. The second codec 206 converts the digital content signal received from the peripheral circuit board 200 into an analog content signal. The analog content signal is carried by the second conductive trace 112. The second codec 206 is electrically coupled to the second conductive trace 112.

The peripheral circuit board 200 includes a front panel input/output (I/O) 204. For example, the I/O may include the second analog output such as the audio speaker 208, the audio jack 210, a universal serial bus (USB), a micro USB, USB 3.0, and/or the like.

Optionally, the analog outputs include the audio jack 204, 210, the audio speaker 208. Additionally or alternatively, the analog outputs include a video jack and/or an analog video display. For example, the I/O 204 may include the video jack. The video jack may include a composite video, S-video, component video, a video graphics array (VGA), and/or the like. The I/O 204 may include an analog video display. The analog video display may represent an interface that connects to computer monitors, laptop computers, projectors, and/or the like. The digital content signal may include digital audio content, digital video content, and/or the like.

FIG. 3 illustrates a process 300 to manage a transfer of a digital content signal over the first and second sets of conductive traces of a main circuit board. For example, the operations of FIGS. 1-2 may be implemented all or in part by the main circuit board 100, the PCH 114, the processor 102, the first and second codecs 106, 206, the peripheral circuit board 200. The processor 102 is under control of program instructions stored on the memories 118, 120 to manage the transfer of a digital content signal over the first and second sets of conductive traces 110, 112.

At 302, the process 300 begins with providing a main circuit board 100 that includes first and second sets of conductive traces 110, 112. For example, the first and second sets of conductive traces 110, 112 may be overlaid on the main circuit board 100. The first and second sets of conductive traces 110, 112 form non-cable digital interfaces to the first and second codecs 106, 206. For example, the first and second sets of conductive traces 110, 112 transmit and/or carry the analog content signal emitted from the first and second codecs 106, 206 to each other.

At 304, the process 300 designates first and second codecs 106, 206 coupled to the first and second edges 122, 124 of the main circuit board 100. For example, the first codec 106 is coupled to the first edge 122 of the main circuit board 100. The second codec 206 is coupled to the second edge 124 of the main circuit board 100 on the peripheral circuit board 200.

At 306, the process 300 outputs first and second analog outputs coupled to the first and second codecs 106, 206. For example, the first and second codecs 106, 206 convert the digital content signal into the analog content signal. The analog content signal is transmitted and/or carried along the first and second conductive traces 110, 112. The analog content signal is received by the PCH 114. The first and second sets of conductive traces 110, 112 include hub contacts 126 coupled to the PCH 114.

Optionally, the PCH 114 determines whether the analog content signal is received by the first and/or second codecs 106, 206. For example, the PCH 114 identifies the connection to the audio jacks 204, 210. Responsive to the connection to the audio jacks 204, 210, the PCH 114 may direct the analog content signal along the first and/or second sets of conductive traces 110, 112.

At 308, the process 300 designates the PCH 114 located on the main circuit board 100. For example, the first and second sets of conductive traces 110, 112 are electrically coupled to the PCH 114. The first and second sets of conductive traces 110, 112 may be terminated at hub contacts 126. For example, the hub contacts 126 may represent a card-edge and/or a socket interface. The PCH 114 may be enclosed in a package that receives an array of pins that directly engage corresponding to the hub contacts 126 of the PCH 114.

At 310, electrically coupling the peripheral circuit board 200 having the second codec 206 and a second analog output mounted thereon. The peripheral circuit board 200 is interconnected with the main circuit board 100 through a card-edge and/or socket interface 202 through an interconnect 108. The second conductive trace 112 extends from the card-edge and/or the socket interface 202 to the second codec 206. For example, the second conductive trace 112 extends through the card-edge and/or the socket interface 202 to the peripheral circuit board 200 from the main circuit board 100.

Optionally, the peripheral circuit board 200 includes the second codec 206. The second codec 206 is coupled to a second edge 124 of the main circuit board 100. The second codec 206 is electrically coupled to the second analog output. The second codec 206 may include one or more memories, a processor, and/or the like. The second codec 206 converts the digital content signal received from the peripheral circuit board 200 into an analog content signal. The analog content signal is carried by the second set of conductive traces 112. The second codec 206 is electrically coupled to the second set of conductive traces 112.

Closing Statements

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the units/modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, in the following claims, the phrases “at least A or B”, “A and/or B”, and “one or more of A and B” (where “A” and “B” represent claim elements), are used to encompass i) A, ii) B and/or iii) both A and B.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

1. An electronic device, comprising:
a main circuit board that includes first and second edges and first and second sets of conductive traces;
memory to store program instructions;
a processor located on the main circuit board, the processor, responsive to the program instructions, to manage transfer of a digital content signal over the first and second sets of conductive traces;
first and second codecs coupled to the first and second edges, respectively, the first and second codecs connected to the first and second sets of conductive traces, respectively, the first and second codecs to convert the digital content signal into an analog content signal; and
first and second analog outputs coupled to the first and second codecs, respectively, the first and second analog outputs to output the analog content signal.

2. The device of claim 1, wherein the first and second sets of conductive traces form non-cable digital interfaces to the first and second codecs.

3. The device of claim 1, wherein the first and second sets of conductive traces include edge contacts coupled to the first and second edges of the main circuit board, the first and second codecs including codec contacts that directly connect to the corresponding edge contacts.

4. The device of claim 1, further comprising a peripheral controller hub (PCH) located on the main circuit board, wherein the first and second sets of conductive traces include hub contacts coupled to the PCH, the PCH including contacts that directly connect to the corresponding hub contacts.

5. The device of claim 1, wherein the main circuit board includes a ground plane extending parallel to the first and second conductive traces.

6. The device of claim 1, further comprising a peripheral circuit board having the second codec and second analog output mounted thereon, the peripheral circuit board interconnecting, through a card-edge and socket interface, to the second set of conductive traces at the second edge of the main circuit board.

7. The device of claim 6, wherein the peripheral circuit board includes a front panel input/output (I/O) that includes the second analog output, and wherein the second analog output includes an audio speaker and audio jack mounted on the front panel I/O.

8. The device of claim 1, wherein the digital content signal comprises at least one of a digital audio content or a digital video content

9. The device of claim 1, wherein the analog outputs comprise at least one of an audio jack, a video jack, an audio speaker, and an analog video display.

10. A method, comprising:
under control of a processor program configured with instructions to transfer a digital content signal over the first and second sets of conductive traces:
providing a main circuit board that includes a first and second sets of conductive traces;
designating first and second codecs coupled to the first and second edges of the main circuit board, respectively, wherein the first and second codecs are connected to the first and second sets of conductive traces, respectively, the first and second codecs converting the digital content signal into an analog content signal; and
outputting first and second analog outputs coupled to the first and second codecs, respectively, wherein the first and second analog outputs output the analog content signal.

11. The method of claim 10, wherein the first and second sets of conductive traces form non-cable digital interfaces to the first and second codecs.

12. The method of claim 10, wherein the first and second sets of conductive traces include edge contacts coupled to the first and second edges of the main circuit board, the first and second codecs including codec contacts that directly connect to the corresponding edge contacts.

13. The method of claim 10, further comprising designating a peripheral controller hub (PCH) located on the main circuit board, wherein the first and second sets of conductive traces include hub contacts coupled to the PCH, the PCH including contacts that directly connect to the corresponding hub contacts.

14. The method of claim 10, wherein the main circuit board includes a ground plane extending parallel to the first and second conductive traces.

15. The method of claim 10, further comprising electrically coupling a peripheral circuit board having the second codec and second analog output mounted thereon, the peripheral circuit board interconnecting, through a card-edge and socket interface, to the second set of conductive traces at the second edge of the main circuit board.

16. The method of claim 15, wherein the peripheral circuit board includes a front panel input/output (I/O) that includes the second analog output, and wherein the second analog output includes an audio speaker and audio jack mounted on the front panel I/O.

17. The method of claim 10, wherein the digital signal includes one or more of digital audio content and digital video content

18. An electronics card, comprising:
a main circuit board that includes first and second edges and first and second sets of conductive traces to transfer a digital content signal;
first and second codecs coupled to the first and second edges, respectively, the first and second codecs connected to the first and second sets of conductive traces, respectively, the first and second codecs to convert the digital content signal into an analog content signal; and
first and second analog outputs coupled to the first and second codecs, respectively, the first and second analog outputs to output the analog content signal.

19. The card of claim 18, wherein the first and second sets of conductive traces form non-cable digital interfaces to the first and second codecs.

20. The card of claim 18, wherein the first and second sets of conductive traces include edge contacts coupled to the first and second edges of the main circuit board, the first and second codecs including codec contacts that directly connect to the corresponding edge contacts.
